(19) United States
(12) Patent Application Publication
(10) Pub. No.: US 2008/0219561 A1
(43) Pub. Date: Sep. 11, 2008

(54) Image processing apparatus, image processing method, and computer program product

(75) Inventor: Toshifumi Yamaai, Kanagawa (JP)

Correspondence Address: HARNESS, DICKEY & PIERCE, P.L.C., P.O. BOX 8910, RESTON, VA, 20195, US

(73) Assignee: Ricoh Company, Limited

(21) Appl. No.: 12/068,496

(22) Filed: Feb. 7, 2008

(30) Foreign Application Priority Data
Mar. 5, 2007 (JP) 2007-053978
Dec. 17, 2007 (JP) 2007-325145

(51) Int. Cl. G06K 9/20

(52) U.S. Cl. 382/199

(57) ABSTRACT

An image processing apparatus includes an image acquiring unit that acquires image data, a characteristic-feature acquiring unit that acquires a characteristic feature of the image data based on pixel value distribution in the image data, a determining unit that determines whether the image data corresponds to captured image data based on the characteristic feature, and an image processing unit that performs image processing on the image data depending on the result of determination obtained by the determining unit.

### CROSS-REFERENCE TO RELATED APPLICATIONS

The present application claims priority to and incorporates by reference the entire contents of Japanese priority document 2007-053978 filed in Japan on Mar. 5, 2007, and 2007-325145 filed in Japan on Dec. 17, 2007.

### BACKGROUND OF THE INVENTION

1. Field of the Invention

The present invention relates to a technology for performing image processing depending on image data.

2. Description of the Related Art

Image processing apparatuses perform image processing on various images. One example of images to be processed is the one that is obtained by optically reading image data from a handwritten document and the like by an image reading apparatus such as a scanner or a digital camera and performing analogue-to-digital (A/D) conversion on the image data (hereinafter, “captured image”). Examples of image processing include binary processing and grayscale processing.

Another example of images to be processed is the one that is obtained by converting a text document generated by a host computer, such as a personal computer, or a display screen of the host computers into image data (hereinafter, “true electronic image”). The true electronic image is electronically generated without performing A/D conversion.

Image processing apparatuses use parameters upon running computer programs for image processing. The parameters are usually set in association with resolution (dots per inch) of image data to be processed. Therefore, if image data of a captured image and a true electronic image contain information on resolution, image processing apparatuses can precisely perform image processing, such as character extraction, based on that resolution.

Information on resolution is contained in some image data, while not contained in others depending on how image data is acquired.

When a captured image is acquired by a scanner, information on resolution is acquired upon reading the captured image by the scanner. However, when a captured image is acquired by a digital camera, only information on pixels is acquired and information on resolution is not acquired.

As for a true electronic image, a true electronic image can be acquired into an image processing apparatus without setting information on resolution. Therefore, like a captured image acquired by a digital camera, a true electronic image sometimes does not contain information on resolution.

If image data does not contain information on resolution, image processing apparatuses cannot perform image processing appropriately. In such a situation, image processing apparatuses use default resolution set in operating system of the image processing apparatuses to perform image processing.

However, image data processed by using default resolution may experience image degradation. For example, a font size (image data size) changes in accordance with default resolution depending on pixels of image data, and thereby the image data fails to be processed as desired by a user.

Furthermore, image processing is performed in different manners on a captured image and on a true electronic image. Specifically, binary processing on a captured image is performed by considering whether an image on a sheet backside is visible from a surface to be scanned, noise, or gamma characteristic at a time of scanning. On the other hand, such considerations are not necessary for a true electronic image. Thus, if image processing is performed on a true electronic image by using the same computer programs and the same parameters as those used in a captured image, processing precision is degraded and a processing speed is lowered.

Japanese Patent Application Laid-open No. 2003-271897 discloses a character recognition apparatus. The character recognition apparatus acquires pixels of characters from a character string read from image data, and calculates resolution by assuming that the font size of acquired characters is standard (e.g., 10.5 points), so that the character recognition apparatus can set parameters based on calculated resolution. As a result, it is possible to perform character extraction in a stable manner.

The above character recognition apparatus can set appropriate resolution to image data that does not contain information on resolution; however, it is still difficult to perform different image processing on a captured image and a true electronic image by using different computer programs and different parameters.

An operator may set appropriate computer programs and parameters to an image processing apparatus depending on whether input image data is of a captured image or a true electronic image. However, it is cumbersome to perform such settings depending on the type of image data every time image processing is performed, and it is difficult to perform such settings in an appropriate manner at all times.

### SUMMARY OF THE INVENTION

It is an object of the present invention to at least partially solve the problems in the conventional technology.

According to an aspect of the present invention, there is provided an image processing apparatus. The image processing apparatus includes an image acquiring unit that acquires image data; a feature acquiring unit that acquires a characteristic feature of the image data; a determining unit that determines type of the image data based on the characteristic feature; and an image processing unit that performs image processing on the image data depending on the type of the image data.

According to another aspect of the present invention, there is provided an image processing method. The image processing method includes receiving image data; acquiring a characteristic feature of the image data; determining type of the image data based on the characteristic feature; and performing image processing on the image data depending on the type of the image data.

According to still another aspect of the present invention, there is provided a computer program product that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image processing apparatus according to a first embodiment of the present invention;

FIG. 2 is a functional block diagram of the image processing apparatus shown in FIG. 1;

FIG. 3 is a flowchart of image processing performed by the image processing apparatus shown in FIG. 1;

FIG. 4 is a histogram of image data for explaining a background area according to the first embodiment;

FIG. 5 is a detailed flowchart of image-data determination processing based on a background area shown in FIG. 3;

FIG. 6 is a functional block diagram of an image processing apparatus according to a second embodiment of the present invention;

FIG. 7 is a histogram of image data for explaining processing target areas according to the second embodiment;

FIG. 8 is a flowchart of image-data determination processing based on color clustering performed by the image processing apparatus shown in FIG. 6;

FIG. 9 is a flowchart of grayscale processing performed on input image data by the image processing apparatus shown in FIG. 6;

FIG. 10 is a flowchart of binary processing performed based on character color obtained from a document file by the image processing apparatus shown in FIG. 6;

FIG. 11 is a flowchart of binary processing performed based on character color obtained using color clustering by the image processing apparatus shown in FIG. 6;

FIG. 12 is a flowchart of skew correction processing performed on input image data by the image processing apparatus shown in FIG. 6;

FIG. 13 is a functional block diagram of an image processing apparatus according to a third embodiment of the present invention;

FIG. 14 is a flowchart of image-data determination processing based on pixel value distribution in a ruled-line area of image data performed by the image processing apparatus shown in FIG. 13;

FIG. 15 is a functional block diagram of an image processing apparatus according to a fourth embodiment of the present invention;

FIG. 16 is an example of binary image data acquired by the image processing apparatus shown in FIG. 15;

FIG. 17 is an enlarged view of a portion of a ruled-line area shown in FIG. 16;

FIG. 18 is a flowchart of image-data determination processing based on the amount of variation in width of a ruled-line area of image data performed by the image processing apparatus shown in FIG. 15; and

FIG. 19 is a functional block diagram of an image processing apparatus according to a fifth embodiment of the present invention.

### DETAILED DESCRIPTION OF THE PREFERRED EMBODIMENTS

Exemplary embodiments of the present invention are explained in detail below with reference to the accompanying drawings.

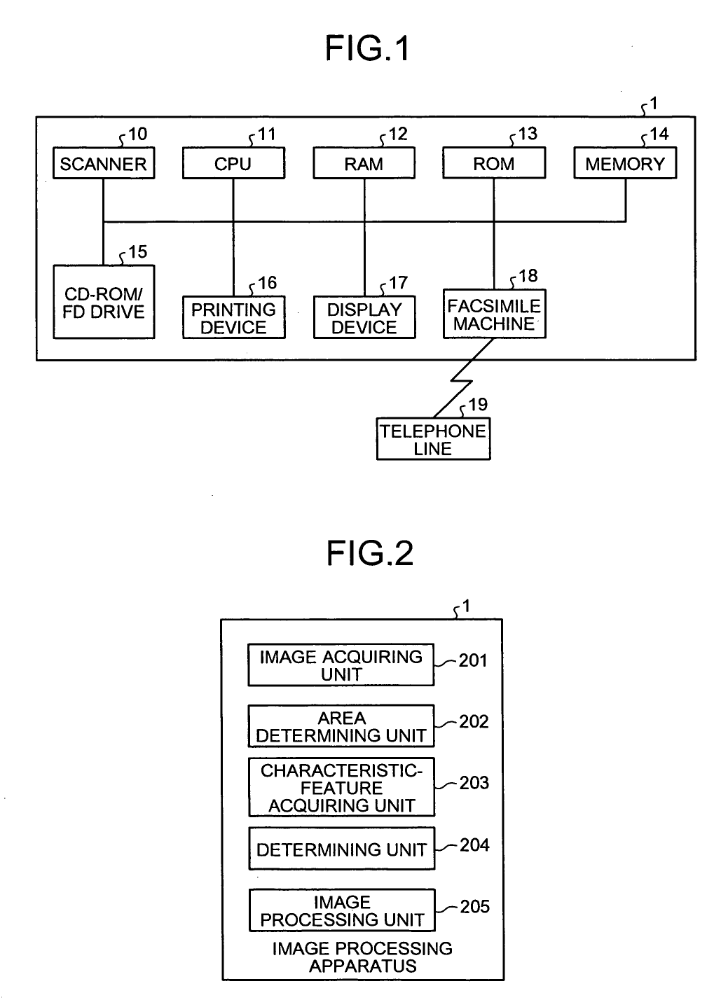

FIG. 1 is a block diagram of an image processing apparatus 1 according to a first embodiment of the present invention. The image processing apparatus 1 includes a scanner 10, a central processing unit (CPU) 11, a random access memory (RAM) 12, a read only memory (ROM) 13, a memory 14, a compact disc (CD)-ROM/FD (flexible disk) drive 15, a printing device 16, a display device 17, and a facsimile machine 18.

In the following embodiments, image processing is explained as being performed on a captured image and a true electronic image. The captured image is optically read by an optical image reading apparatus, such as a scanner or a digital camera. The true electronic image is not read by an optical image reading apparatus after the image is generated. Examples of the true electronic image include text image data and image data generated by a predetermined application, and image data in a format converted from the text image data or the image data.

The scanner 10 optically reads text or images on an original document, and converts read text or images into image data. The read image data is converted into either monochrome image data (image in white and black) or color image data (multilevel image), and stored in the memory 14. An image optically read and stored in a memory in the above manner is considered as a captured image.

The CPU 11 executes a computer program for image processing (hereinafter, “image processing program”) stored in, for example, the ROM 13 set in the CD-ROM/FD drive 15, and controls functional units of the image processing apparatus 1.

The RAM 12 temporarily stores therein computer programs to be executed by the CPU 11, and serves as a work area when the CPU 11 executes them.

The ROM 13 stores therein various data, the image processing program, and the like to be executed by the CPU 11. Examples of data stored in the ROM 13 include a threshold for determining whether image data is of a captured image or a true electronic image.

The memory 14 temporarily stores therein image data read by the scanner 10 and processed image data acquired by performing image processing.

The CD-ROM/FD drive 15 and the printing device 16 read computer programs to be executed by the CPU 11 from a CD-ROM or an FD.

The printing device 16 prints image data onto a sheet and the like upon receipt of a printing instruction.

The display device 17 displays settings or states of the image processing apparatus 1. The display device 17 also displays processed image data as appropriate.

The facsimile machine 18 transmits image data and the like stored in the memory 14 to an external image processing apparatus via a telephone line 19.

The scanner 10, the printing device 16, and the facsimile machine 18 are integrally installed in the image processing apparatus 1; however, they can be individually connected to the image processing apparatus 1 via a network.

The image processing apparatus 1 determines the type of image data, i.e., whether image data to be processed is of a captured image or a true electronic image, and performs appropriate image processing based on a determination result.

The type of image data can be determined, if image data is stored in Exchangeable Image Format (EXIF), by previously adding information indicative of a captured image or a true electronic image to a tag of EXIF.

Assuming that character extraction processing is performed on text image data, if the image data is of a captured image, the processing is performed through optical character recognition (OCR) to acquire text information. On the other hand, if the image data is of a true electronic image, the processing can be performed more accurately by acquiring text information from original electronic information (e.g., text data before being converted into image data) instead of using the OCR.

FIG. 2 is a functional block diagram of the image processing apparatus 1. The image processing apparatus 1 includes an image acquiring unit 201, an area determining unit 202, a characteristic-feature acquiring unit 203, a determining unit 204, and an image processing unit 205.

The image acquiring unit 201 receives input of target image data. Examples of the target image data include image data stored in the memory 14 and image data received via a network (not shown).

The area determining unit 202 determines a target area to be processed. In the first embodiment, a background area is used as the target area. Specifically, the area determining unit 202 determines a background area of image data, and specifies an area containing uniform pixel values in the background area.

This is because when an image is optically read, and read data is converted from analogue data to digital data, this A/D conversion may cause image noise. For example, when a background color is white in an original image, if image noise occurs due to characteristic features of pixels or optical reading of the image, values of RGB (Red, Green, Blue) of the background color may change from uniform values (i.e., “FFFFFF”) to nonuniform values (e.g., “FFF4EF” or “FAD9FA”). Furthermore, upon optically reading a sheet, the image processing apparatus 1 may scan an image on the backside of the sheet, which is not a target image. In general, a captured image has characteristic features described above. Thus, the image processing apparatus 1 determines a background area as the target area to be processed, and determines whether an original image is a captured image by acquiring the characteristic features.

The characteristic-feature acquiring unit 203 acquires a characteristic feature indicative of pixel value distribution (variation) from image data. Specifically, the characteristic-feature acquiring unit 203 acquires pixel value distribution in an area determined by the area determining unit 202.

The determining unit 204 determines whether a read image is a captured image or a true electronic image based on an acquired characteristic feature (distribution value). Specifically, the determining unit 204 determines that an original image is a captured image when an acquired distribution value is larger than a threshold set in the ROM 13. On the other hand, when an acquired distribution value is equal to or smaller than the threshold, the determining unit 204 determines that an original image is a true electronic image.

The image processing unit 205 performs different image processing on image data depending on whether the image data is of a captured image or a true electronic image.

As described above, the image processing apparatus 1 selects an appropriate image processing depending on whether input image data is of a captured image or a true electronic image, and performs selected image processing.

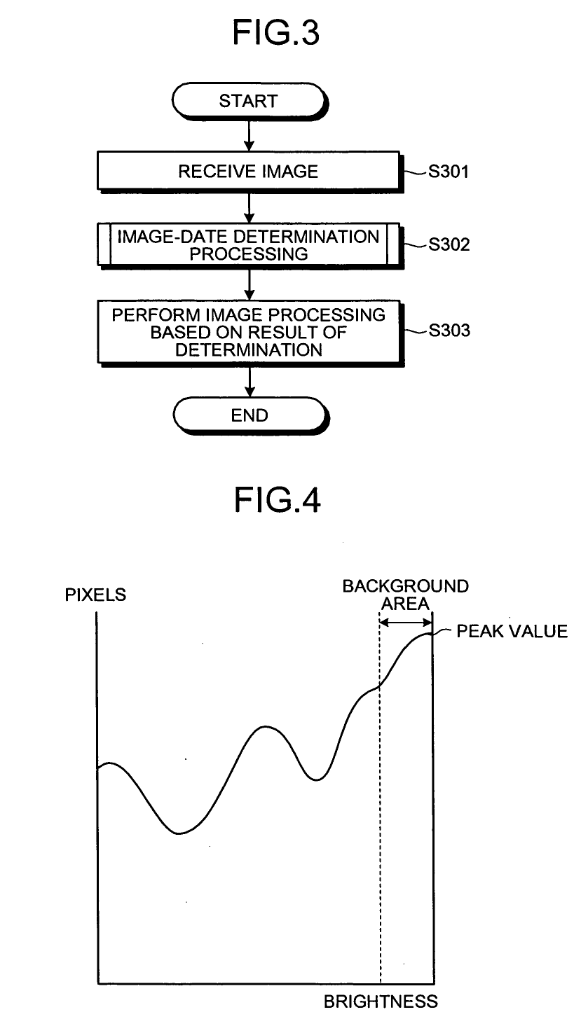

FIG. 3 is a flowchart of image processing performed by the image processing apparatus 1.

The image acquiring unit 201 acquires image data from the scanner 10 (step S301). The determining unit 204 performs image-data determination processing. Specifically, the determining unit 204 determines the type of acquired image data, i.e., whether image data to be processed is of a captured image or a true electronic image, based on a result of processing performed by the area determining unit 202 and the characteristic-feature acquiring unit 203 (step S302). Upon determining whether image data is of a captured image or a true electronic image, the image processing unit 205 selects an image processing method depending on the type of the image data, and performs selected image processing (step S303).

As described above, upon performing predetermined image processing (e.g., grayscale processing or character extraction processing), the image processing apparatus 1 determines the type of input image data, and performs appropriate image processing depending on a result of determination so that the image processing can be performed with high precision or at a high-speed.

A method how the image processing apparatus 1 determines whether input image data is of a captured image or a true electronic image is described in detail below.

A true electronic image has such a characteristic feature that pixel values are uniform in a white area. That is, if an area of image data is in white, all the pixel values in the area are (R, G, B)=(255, 255, 255).

On the other hand, when the scanner 10 reads an image in white (a captured image), it is likely that not all the pixel values of the image are (R, G, B)=(255, 255, 255) because of a characteristic feature of elements in the scanner 10 or image noise. Therefore, pixel values of a large area, e.g., a background area, are usually not uniform in the captured image.

The area determining unit 202 determines a likely background area of image data, and the characteristic-feature acquiring unit 203 calculates pixel value distribution of a determined background area. A calculated distribution value of a captured image is distinctly different from that of a true electronic image. Thus, the determining unit 204 determines the type of image data based on the calculated distribution value.

A background area is determined by using a known technology as disclosed in Japanese Patent Application Laid-Open No. 2001-297303, and a threshold for determination is previously stored in the ROM 13.

It is also possible to determine a background area by assuming that an area in a predetermined range from a peak value shown in a histogram of image data serves as the background area. FIG. 4 is a histogram of image data for determining a background area from a peak value. In the histogram of FIG. 4, an area having brightness of the peak value can be determined as a background area. Specifically, an area in a predetermined range from the peak value is determined as a background area. Then, it is determined whether an image is a captured image based on pixel value distribution of the background area. The background area can be determined by other methods.

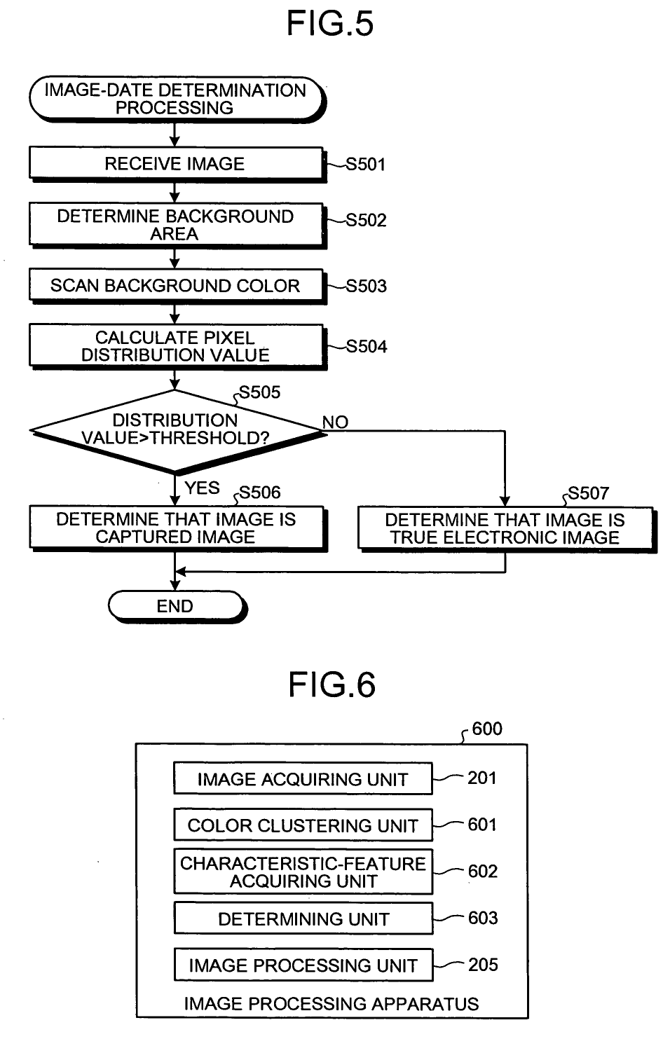

FIG. 5 is a detailed flowchart of image-data determination processing performed at step S302 in FIG. 3.

The area determining unit 202 acquires image data to be processed (step S501). The area determining unit 202 determines a background area of the image data, which is an area where pixel values are uniform (step S502).

Upon determination of the background area, the characteristic-feature acquiring unit 203 scans pixels of color in the background area (step S503), and calculates a pixel value distribution of the background area (step S504).

The determining unit 204 compares the pixel value distribution with a threshold previously set in the image processing apparatus 1 (step S505). When the pixel value distribution is larger than the threshold (Yes at step S505), the determining unit 204 determines that the image data is of a captured image because pixel values in the background area are not uniform (step S506). On the other hand, when the pixel value distribution is equal to or smaller than the threshold (No at step S505), the determining unit 204 determines that the image data is of a true electronic image because pixel values in the background area are uniform (step S507).

The image processing apparatus 1 determines whether an image is a captured image or a true electronic image in the above manner. Accordingly, the image processing apparatus 1 causes the image processing unit 205 to perform appropriate image processing depending on whether an image is a captured image or a true electronic image. As a result, image processing can be performed more precisely.

It is possible to determine whether image data is of a captured image or a true electronic image based on other factors instead of pixel value distribution in a background area of the image data. A second embodiment of the present invention is described below in which color clustering is used for determination of the type of image data.

FIG. 6 is a functional block diagram of an image processing apparatus 600 according to the second embodiment. The image processing apparatus 600 includes the image acquiring unit 201, a color clustering unit 601, a characteristic-feature acquiring unit 602, a determining unit 603, and the image processing unit 205. The image processing apparatus 600 does not include the area determining unit 202 unlike the image processing apparatus 1. The characteristic-feature acquiring unit 602 and the determining unit 603 operate differently from the characteristic-feature acquiring unit 203 and the determining unit 204. The same components are assigned with the same reference numerals as those in the first embodiment, and their explanations are omitted.

The color clustering unit 601 performs color clustering on image data on which image processing has been performed, and forms color clusters. Examples of the color clusters include a cluster of colors of a background area, and a cluster of colors of a text area. The color clustering is a method of grouping colors in image data with respect to each range of pixel values.

The characteristic-feature acquiring unit 602 acquires a characteristic feature indicative of pixel value distribution of image data. Specifically, the characteristic-feature acquiring unit 602 acquires pixel value distribution with respect to each color cluster formed by the color clustering unit 601.

The determining unit 603 determines whether image data is of a captured image or a true electronic image based on a characteristic feature (distribution value) for each of the color clusters.

The captured image causes image noise when the optically read. To detect such image noise, it is necessary to determine a target area in the captured image from which the image noise is detected. A background area is used as the target area in the first embodiment; however, image noise is also present in other areas (contents area) of the captured image. Therefore, according to the second embodiment, not only the background area but also the contents area are assumed as the target areas. That is, it is determined whether image data is of a captured image or a true electronic image based on pixel value distribution for each color cluster (e.g., color of a background area, color of a text area, color of a predetermined area of a graph). As a result, the type of an image can be determined more precisely. Thus, it is possible to perform such determination even when color of a background area is gradient, or even after image noise is removed from a background area.

The true electronic image is generally formed in a limited number of colors unless the true electronic image contains a gradient image such as a photograph or gradation of colors. Examples of the true electronic image include a text image obtained from text data.

On the other hand, the captured image is generally formed in a number of colors, and contains a highly gradient image. For example, when the captured image is a text image, even a line of the same character is in gradient colors. In other words, some portions are darker than other portions of the character, and a boundary between the character and a background area is formed in mixed colors of color of the character and color of the background area.

As described above, the color clustering unit 601 performs color clustering, the characteristic-feature acquiring unit 602 calculates the number of color clusters in image data and pixel value distribution of each of the color clusters, and the determining unit 603 determines whether a calculated distribution value is larger than a threshold or equal to or smaller than the threshold. As a result, it is possible to determine whether the image is a captured image or a true electronic image. Specifically, when the distribution value is larger than a threshold, it is determined that an image is a captured image because a large distribution value indicates presence of a number of colors, which is a characteristic feature of the captured image. On the other hand, when the distribution value is equal to or smaller than the threshold, it is determined that an image is a true electronic image because a small distribution value indicates that the number of colors used in the image is limited, which is a characteristic feature of the true electronic image.

The determining unit 603 performs a determination process by using a threshold previously stored in the ROM 13. Alternatively, it is possible to set an appropriate threshold depending on the number of clusters and a distribution value of each of the clusters.

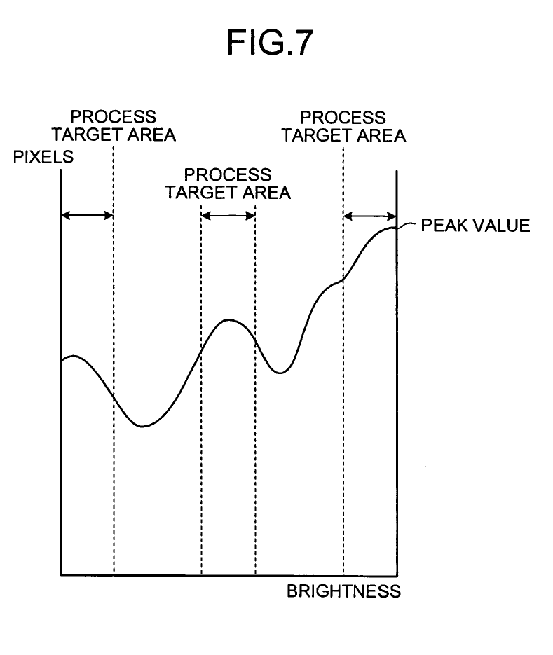

The color clustering unit 601 performs color clustering by using known technologies. FIG. 7 is a histogram of image data for explaining areas to be processed by the image processing apparatus 600. It can be seen from FIG. 7 that, when a plurality of color clusters are formed by color clustering, a plurality of peak values are respectively present for the color clusters. Consequently, a plurality of areas in a predetermined range of brightness from the peak values are considered as areas to be processed. A pixel value distribution is calculated for each of the areas to be processed, so that it is possible to determine whether an image is a captured image or a true electronic image based on the pixel value distribution.

The image processing apparatus 600 perform image processing in basically the same manner as previously described in connection with FIG. 3 except image-data determination processing, and therefore, the same explanation is not repeated.

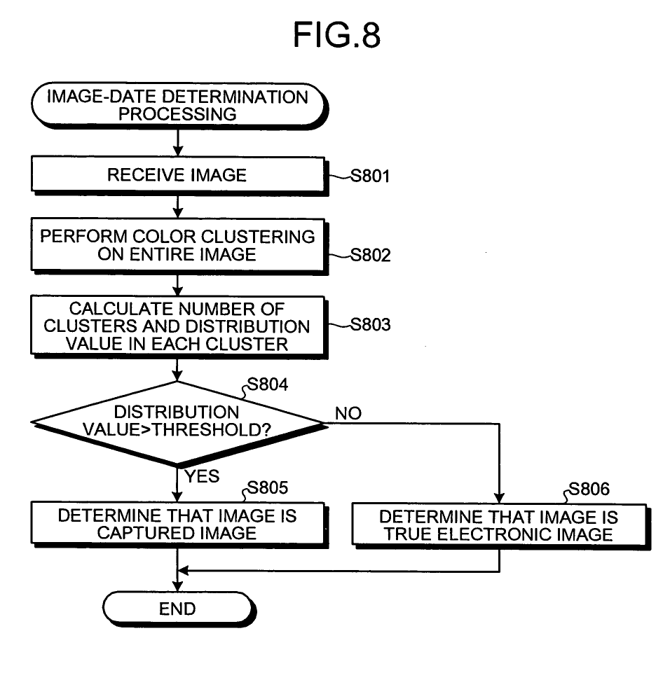

FIG. 8 is a flowchart of image-data determination processing based on color clustering performed by the image processing apparatus 600.

The color clustering unit 601 acquires image data to be processed (step S801), and performs color clustering of the entire image (step S802). The characteristic-feature acquiring unit 602 calculates the number of clusters and a distribution value for each of the clusters (step S803). The determining unit 603 compares the distribution value with a threshold with respect to each cluster (e.g., a threshold X1 is used when the number of clusters is smaller than four, while a threshold X2 is used when the number of clusters is equal to or larger than four) (step S804).

When the distribution values of all the clusters are larger than thresholds (Yes at step S804), the determining unit 603 determines that an image is a captured image (step S805). When at least one of the distribution values is equal to or smaller than a threshold (No at step S804), the determining unit 603 determines that an image is a true electronic image (step S806).

Thus, the image processing apparatus 600 determines whether input image data is of a captured image or a true electronic image through the processing shown in FIG. 8. As a result, it is possible for a user to input image data to an image processing apparatus without considering the type of the image data (whether the image data is of a captured image or a true electronic image).

Image processing performed by the image processing apparatus 600 depending on the type of image data is described below. The image processing apparatus 1 also performs the same processing.

Examples of the image processing include grayscale processing, binary processing, character extraction processing, and edge processing. The image processing can be performed in various manners. Specifically, in the grayscale processing, a multilevel image is converted into a grayscale image in 256 tones (brightness) of white to black by calculating the brightness from pixel values of each pixel in the multilevel image (pixel values of red, green, blue in one of 256 tones of each color).

One method of calculating the brightness is to calculate the brightness from pixel values of red, green, blue for each pixel as described above. Alternatively, it is possible to use a pixel value of green for each pixel as the brightness. The former method requires more time; however, a highly precise image can be obtained. The latter method achieves high-speed image processing; however, when original image data in limited colors is processed, it is difficult to obtain a highly precise image.

As described above, image processing can be performed in various manners. The true electronic image contains pure colors, e.g., pure green represented by (R, G, B)=(0, 255, 0). If a pixel value of green is used as the brightness of the entire image, a portion in pure green is processed to be white by the image processing. Therefore, it is preferable to calculate the brightness from pixel values of red, green, blue for each pixel in the true electronic image.

On the other hand, even if a pixel value of green is used as the brightness of the captured image, processing speed increases and precision of a processed image is not much degraded because the captured image contains a number of gradient colors. Therefore, it is preferable to use a pixel value of green as the brightness of the captured image.

The image processing apparatus 600 thus selects and performs appropriate image processing depending on the type of image data to be processed.

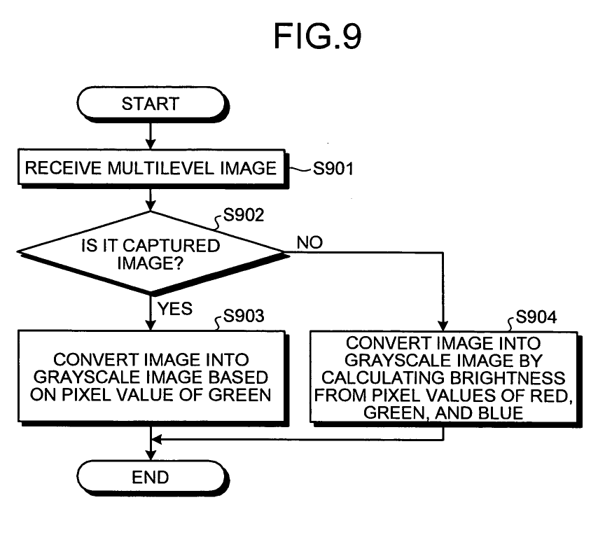

FIG. 9 is a flowchart of grayscale processing performed on input image data by the image processing apparatus 600.

The image processing unit 205 acquires image data of a multilevel image (step S901), and determines whether the image data is of a captured image or a true electronic image based on a result of determination obtained through processing shown in FIG. 8 (step S902).

When the image data is of a captured image (Yes at step S902), the image processing unit 205 converts the image data into a grayscale image by high-speed processing, i.e., converts the image data into a grayscale image by using a pixel value of green for each pixel as the brightness (step S903).

On the other hand, when the image data is a true electronic image (No at step S902), the image processing unit 205 converts the image data into a grayscale image by calculating the brightness from pixel values of red, green, blue for each pixel of the true electronic image (step S904).

Similarly, binary processing can be performed on image data of a text image in various manners.

Examples of binary processing include the one in which each pixel value of image data is compared with a threshold. A pixel equal to or smaller than the threshold is converted into white while a pixel larger than the threshold is converted into black to form a monochrome image in black and white.

In a text image of the true electronic image, the same color has the same pixel value. For example, black characters are uniformly represented by (R, G, B)=(0, 0, 0). Therefore, a true electronic image can be converted into a grayscale image effectively by previously acquiring information on character color, and converting pixels of character colors into black while converting pixels of other colors into white.

Information on character color can be acquired by using various methods. For example, information on character color is acquired by previously acquiring positions of characters from a text file (text data before being converted into image data) by using known technologies. Color clustering is then performed to classify the same color into a group with respect to each pixel values, and a group having a small pixel value is determined to correspond to text.

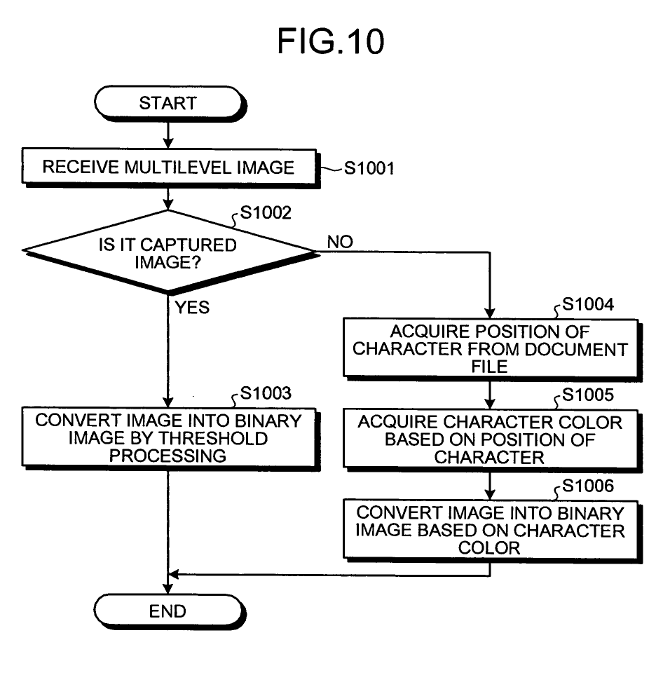

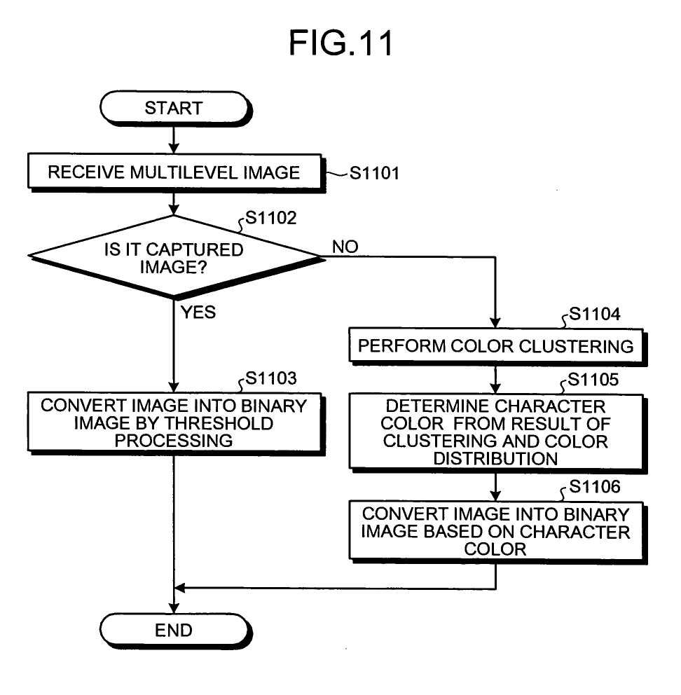

FIGS. 10 and 11 are flowcharts of binary processing performed by the image processing apparatus 600. Thresholds used in each processing are stored in the ROM 13.

The binary processing shown in FIG. 10 is performed based on information on character color obtained from a document file. Processes performed at steps S1001 and S1002 are the same as those at steps S901 and S902 shown in FIG. 9; therefore, their explanations are omitted.

When it is determined that input image data is of a captured image (Yes at step S1002), the image processing unit 205 compares the pixel value of each pixel in the image data with a threshold thereby converting the image data into a binary image (step S1003).

When it is determined that input image data is of a true electronic image (No at step S1002), the image processing unit 205 acquires positions of characters from a text file which has not been converted into image data (step S1004), and acquires pixel values of acquired positions, i.e., character color (step S1005). The image processing unit 205 then converts the image data into a binary image based on acquired character color by converting the character color into black and other colors into white (step S1006).

The binary processing shown in FIG. 11 is performed based on information on character color obtained using color clustering performed by the image processing unit 205.

Processes performed at steps S1101 and S1102 are the same as those at steps S901 and S902 shown in FIG. 9; therefore, their explanations are omitted.

When it is determined that input image data is of a captured image (Yes at step S1102), the image processing unit 205 compares the pixel value of each pixel in the image data with a threshold thereby converting the image data into a binary image (step S1103).

When it is determined that input image data is of a true electronic image (No at step S1102), the color clustering unit 601 performs color clustering (step S1104), and determines character color from a result of color clustering and a distribution of colors (step S1105). The image processing unit 205 then converts the image data into a binary image based on character color by converting the character color into black and other colors into white (step S1106).

In the processing described in connection with FIGS. 10 and 11, when input image data is of a true electronic image, the image data is converted into a binary image by converting character color into black and other colors into white. However, it is possible to convert text (character) portion into the first color and convert other portions into the second color. In other words, image data can be converted into a binary image based on text portions and other portions.

To correct skew in image data, it is necessary to change values of parameters depending on the type of image data.

A captured image may contain skew due to reading by the scanner 10. For example, when a document with an image to be read by the scanner 10 is obliquely set to a reading direction of the scanner 10, it causes skew in the captured image. If skew is present in the captured image, it needs to be corrected.

On the other hand, a true electronic image is electronically formed, and therefore, skew caused by setting of a document does not occur. Thus, when image data read by the image processing apparatus 600 is of a true electronic image, a skew angle to be corrected is automatically set to be zero. That is, skew correction is not performed.

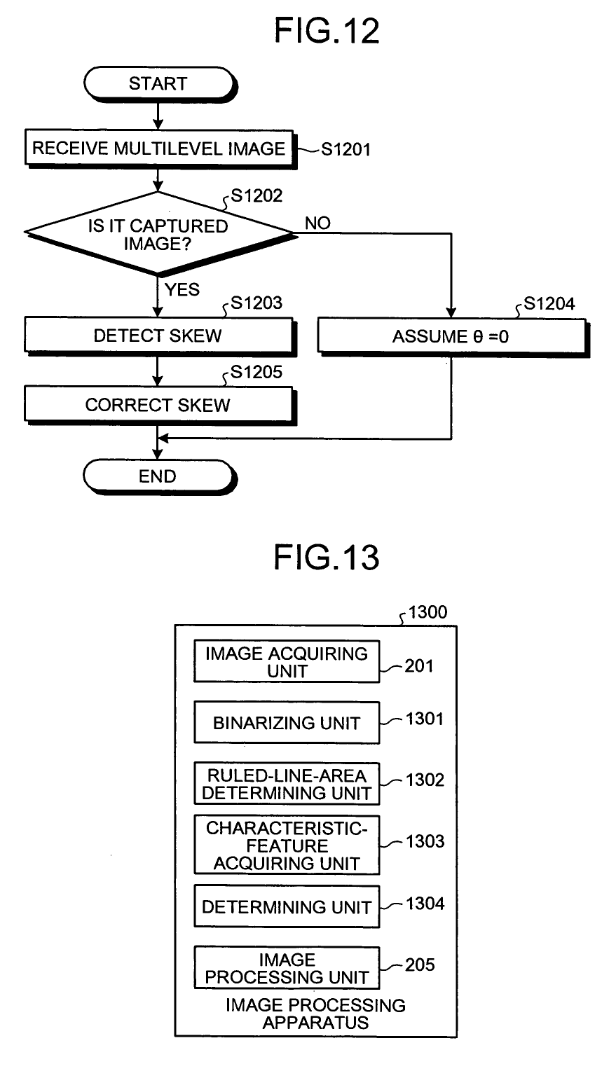

FIG. 12 is a flowchart of skew correction processing performed on input image data by the image processing unit 205. The skew correction processing can be performed in the first and the second embodiments.

Processes performed at steps S1201 and S1202 are the same as those at steps S901 and S902 shown in FIG. 9; therefore, their explanations are omitted.

When it is determined that input image data is of a captured image (Yes at step S1202), the image processing unit 205 detects skew by using known technologies to obtain a skew angle θ (step S1203), and corrects skew θ (step S1205).

On the other hand, when it is determined that input image data is of a true electronic image (No at step S1202), the image processing unit 205 automatically sets a skew angle θ to be zero (step S1204), i.e., does not perform skew correction.

As described above, the image processing apparatus 600 determines the type of input image data, and performs image processing, such as grayscale processing, binary processing, and skew correction, in an efficient manner and with high precision depending on the type of input image data.

The processes described in connection with FIGS. 3, 5, and 8 to 12 are implemented by the image processing program. The image processing program is stored in, for example, the ROM 13, and executed by the CPU 11 on the image processing apparatus 1.

According to the first and second embodiments, whether image data is of a captured image or a true electronic image is determined based on pixel value distribution in a determined area, such as a background area, of the image data. Alternatively, it is possible to perform such determination based on a characteristic feature caused by optical reading of image data. A third embodiment of the present invention is described below in which the type of image data is determined based on a ruled-line area.

FIG. 13 is a functional block diagram of an image processing apparatus 1300 according to the third embodiment. The image processing apparatus 1300 includes the image acquiring unit 201, a binarizing unit 1301, a ruled-line-area determining unit 1302, a characteristic-feature acquiring unit 1303, a determining unit 1304, and the image processing unit 205. The characteristic-feature acquiring unit 1303 and the determining unit 1304 operate differently from the characteristic-feature acquiring unit 203 and the determining unit 204. The same components are assigned with the same reference numerals as those of the image processing apparatus 1, and their explanations are omitted.

The binarizing unit 1301 performs binary processing on input image data thereby generating binary image data.

The ruled-line-area determining unit 1302 determines a ruled-line area from binary image data. A ruled-line area can be determined by using various methods. For example, a group of black pixels in a run length of equal to or longer than a threshold is extracted from image data, and an extracted group is integrated with another group of black pixels connected with the extracted group. The integrated groups are then extracted as a solid ruled line. If an extracted solid ruled line has a run length of equal to or longer than a predetermined threshold, it is recognized as a ruled line.

The characteristic-feature acquiring unit 1303 acquires pixel value distribution from binary image data. Specifically, the characteristic-feature acquiring unit 1303 calculates pixel value distribution in an area of input image data (image data before being converted into a binary image) corresponding to a ruled-line area determined by the ruled-line-area determining unit 1302.

Ruled lines used for tables and boxes in general documents are usually formed in monochrome color. In other words, it is rare that ruled lines are formed in multi colors or gradient colors. For a true electronic image, pixel value distribution of such ruled lines is considered as zero because the ruled lines are in the same color. On the other hand, for a captured image, color of ruled lines changes into gradient colors or similar colors because of optical reading. For example, when a sheet medium to be optically read is a printed object, colors on the sheet medium is usually expressed by dots, and an area seemingly of the same color consists of various colors. When such a sheet medium is optically read by a scanner, as an image is optically read with higher resolution, dots are more precisely resolved, resulting in large distribution of colors in a target area. Such color change occurs also due to image noise by optical reading.

It can be considered, as described above, that pixel value distribution hardly occurs in a ruled-line area in a binary image of a true electronic image. On the other hand, it can be considered that pixel value distribution usually occurs in a captured image. According to the third embodiment, the characteristic-feature acquiring unit 1303 calculates pixel value distribution in an area of input image corresponding to a ruled-line area of a binary image. Thus, it is possible to determine whether an image is a captured image or a true electronic image.

The determining unit 1304 determines whether an image is a captured image or a true electronic image based on a distribution value in a ruled-line area calculated by the characteristic-feature acquiring unit 1303. Specifically, the determining unit 1304 determines that an image is a captured image when a distribution value is equal to or larger than a predetermined threshold.

If a plurality of ruled lines are acquired, the determining unit 1304 performs determination by using various methods. One example is that the determining unit 1304 sequentially performs the above processes on each of acquired ruled lines, and determines that an image is a captured image immediately after a ruled line having a color distribution value larger than a predetermined threshold is detected. Then, the process ends at the time of detection without processing the rest of the ruled lines. Another example is that the determining unit 1304 performs the above processes on all ruled lines, and determines that image data is a captured image data when the number of ruled lines having distribution values larger than a threshold exceeds the number of ruled lines having distribution values equal to or smaller than a threshold.

The image processing apparatus 1300 performs image processing in basically the same manner as previously described in connection with FIG. 3 in the first embodiment; therefore, the same explanation is not repeated.

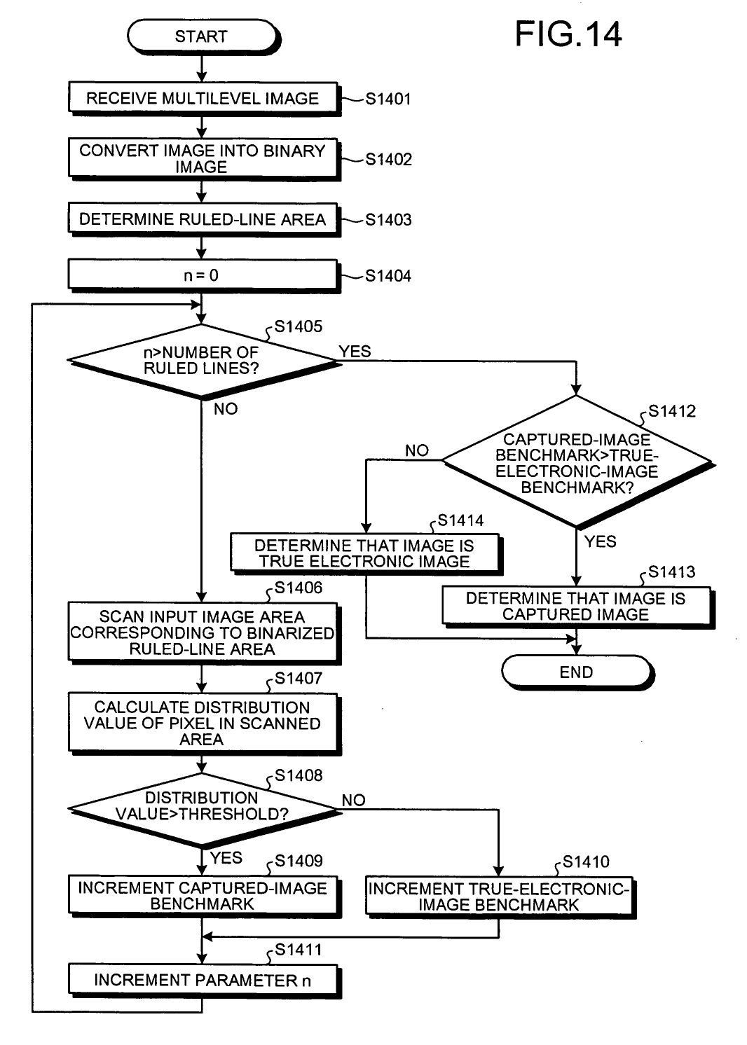

FIG. 14 is a flowchart of image-data determination processing performed by the image processing apparatus 1300 by using a ruled-line area of image data.

The area determining unit 202 acquires multilevel (multi-color) image data to be processed (step S1401). The binarizing unit 1301 performs binary processing on acquired image data thereby generating binary image data (step S1402).

The ruled-line-area determining unit 1302 determines a ruled-line area from the binary image data (step S1403). The characteristic-feature acquiring unit 1303 initializes a parameter n to zero (step S1404). The characteristic-feature acquiring unit 1303 also initializes a captured-image benchmark and a true-electronic-image benchmark to zero. The captured-image benchmark is referred to for determining that an image is a captured image, while the true-electronic-image benchmark is referred to for determining that an image is a true electronic image.

The characteristic-feature acquiring unit 1303 determines whether parameter n is larger than the number of ruled lines (step S1405). When the number of ruled lines is equal to or smaller than parameter n (No at step S1405), the characteristic-feature acquiring unit 1303 scans an image area of input image data corresponding to a ruled-line area of binary image data (step S1406).

Then, the characteristic-feature acquiring unit 1303 calculates a distribution value of pixel values in a scanned area (step S1407).

The determining unit 1304 determines whether a calculated distribution value is larger than a predetermined threshold (step S1408). When the distribution value is larger than the predetermined threshold (Yes at step S1408), the determining unit 1304 increments the captured-image benchmark (step S1409). On the other hand, when the distribution value is equal to or smaller than the predetermined threshold (No at step S1408), the determining unit 1304 increments the true-electronic-image benchmark (step S1410).

The characteristic-feature acquiring unit 1303 increments parameter n (step S1411), and determines whether parameter n is larger than the number of ruled lines (step S1405).

When parameter n is larger than the number of ruled lines (Yes at step S1405), the determining unit 1304 determines whether the captured-image benchmark is larger than the true-electronic-image benchmark (step S1412). When the captured-image benchmark is larger than the true-electronic-image benchmark (Yes at step S1412), the determining unit 1304 determines that an image is a captured image (step S1413), and the process ends.

On the other hand, when the captured-image benchmark is equal to or smaller than the true-electronic-image benchmark (No at step S1412), the determining unit 1304 determines that an image is a true electronic image (step S1414), and the process ends.

According to the third embodiment, it is possible to increase a processing speed, and reduce memory usage in addition to achievement of effects described in the first and the second embodiments. Specifically, the image processing apparatus 1300 can precisely determine whether input image data is a captured image or a true electronic image. Accordingly, it is possible to select an appropriate image processing depending on a characteristic feature of the input image. Furthermore, the image processing apparatus 1300 can determine whether input image data is a captured image or a true electronic image even when the input image data is a binary image.

It is explained in the third embodiment that whether input image data is of a captured image or a true electronic image is determined based on pixel value distribution in a ruled-line area. However, it is possible to use other features of a ruled line area instead of a pixel value distribution. A method of determining the type of image data based on a width of a ruled line is explained in a fourth embodiment of the present invention.

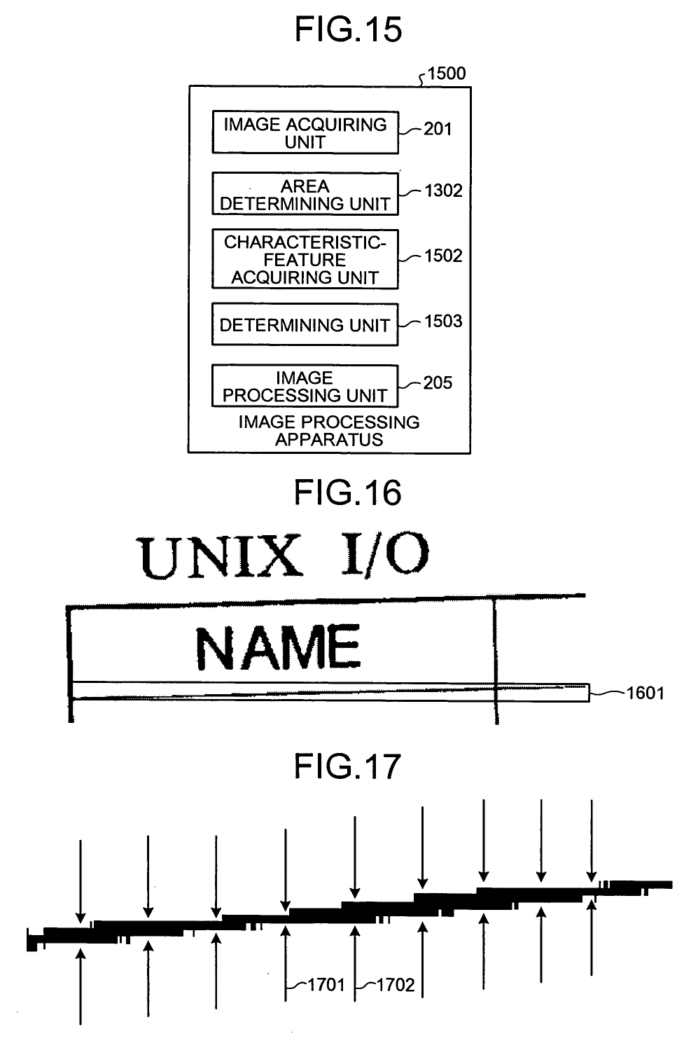

FIG. 15 is a functional block diagram of an image processing apparatus 1500 according to the fourth embodiment. The image processing apparatus 1500 is different from the image processing apparatus 1300 in that the image processing apparatus 1500 includes a characteristic-feature acquiring unit 1502 and a determining unit 1503, which operate differently from the characteristic-feature acquiring unit 1303 and the determining unit 1304. The same components are assigned with the same reference numerals, and their explanations are omitted.

It is assumed that the image processing apparatus 1500 processes binary image data.

In the method described in the third embodiment, whether input image data is a captured image or a true electronic image is determined based on colors (brightness) because the input image data is multilevel image data. However, if input image data is binary image data, that method is not applicable. According to the fourth embodiment, the image processing apparatus 1500 determines whether input image data is a captured image or a true electronic image even when the input image data is binary image data.

The image acquiring unit 201 acquires binary image data, and the ruled-line-area determining unit 1302 determines a ruled-line area from the binary image data.

The characteristic-feature acquiring unit 1502 acquires the amount of variation (distribution value) in width of a ruled line from the ruled-line area of the binary image data. Specifically, the characteristic-feature acquiring unit 1502 calculates the amount of variation in width of a ruled line from a ruled-line area determined by the ruled-line-area determining unit 1302. In other words, the characteristic-feature acquiring unit 1502 measures a width of each ruled line instead of a length of each ruled line.

FIG. 16 is an example of binary image data acquired by the image processing apparatus 1500. A ruled line in a ruled-line area 1601 shown in FIG. 16 is to be processed to acquire the amount of variation in width.

FIG. 17 is an enlarged view of a portion of the ruled line in the ruled-line area 1601. If a ruled line is horizontally arranged, a width of a ruled line can be detected by measuring a run length of the ruled line from one end to the other end in an orthogonal direction. In the example shown in FIG. 17, the characteristic-feature acquiring unit 1502 measures a width of a ruled line with respect to each predetermined interval represented by arrows. It can be seen in FIG. 17 that a width 1701 and a width 1702 are different from each other as a result of measurement.

The characteristic-feature acquiring unit 1502 measures a width of ruled lines to be measured. If a ruled line is orthogonally arranged, a width of the ruled line can be acquired by measuring a run length of the ruled line in a horizontal direction. If a ruled line is inclined, a horizontal run length of an orthogonally-arranged ruled line is not identical to a width of the ruled line in a technical sense.

The determining unit 1503 determines whether an image is a captured image or a true electronic image based on a measured width of a ruled line (distribution value of dots in the ruled line). Specifically, a threshold is previously determined, and the determining unit 1503 determines that an image is a captured image when the amount of variation in width of a ruled line is equal to or wider than the predetermined threshold. In this method, an absolute value of a width of a ruled line is not necessary, while the amount of variation in width is necessary. Therefore, even when a ruled line is slightly inclined, it is possible to acquire the amount of variation in width. A threshold for determining the amount of variation is determined based on a result of experiments.

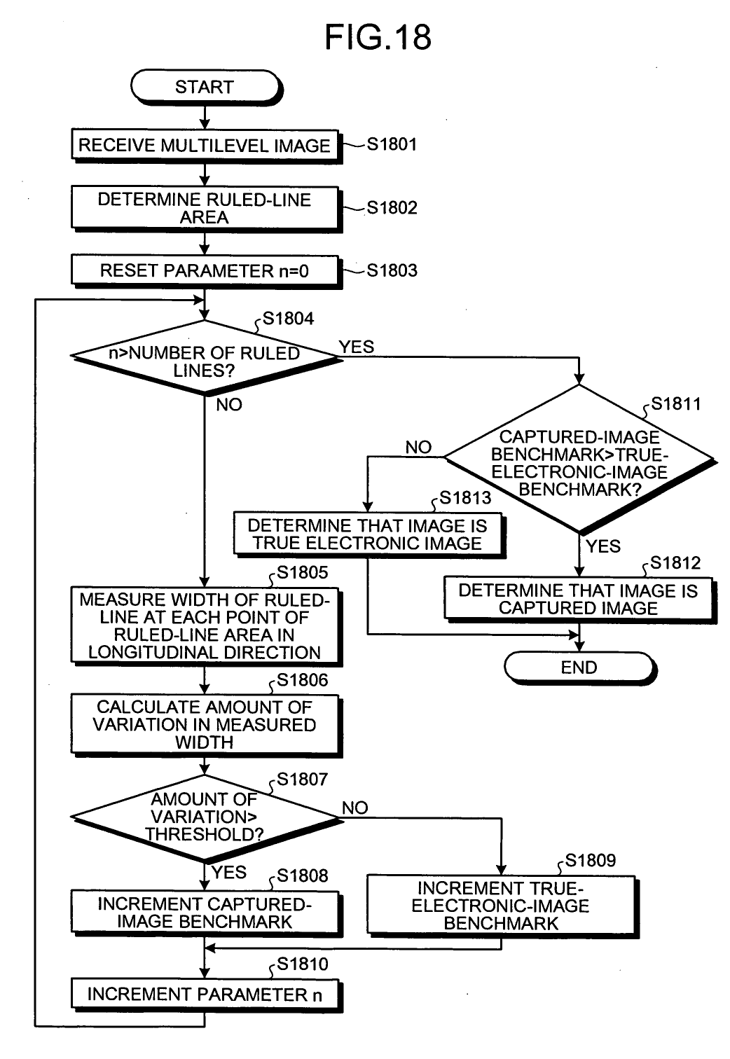

FIG. 18 is a flowchart of image-data determination processing performed by the image processing apparatus 1500 by using a ruled-line area of image data.

The area determining unit 202 acquires binary image data to be processed (step S1801).

The ruled-line-area determining unit 1302 determines a ruled line area from the binary image data (step S1802). The characteristic-feature acquiring unit 1502 initializes parameter n to zero (step S1803). The characteristic-feature acquiring unit 1502 also initializes a captured-image benchmark and a true-electronic-image benchmark to zero. The captured-image benchmark is referred to for determining that an image is a captured image, while the true-electronic-image benchmark is referred to for determining that an image is a true electronic image.

The characteristic-feature acquiring unit 1502 determines whether parameter n is larger than the number of ruled lines (step S1804). When parameter n is equal to or smaller than the number of ruled lines (No at step S1804), the characteristic-feature acquiring unit 1502 measures a width of a ruled line at predetermined positions of a ruled-line area of the binary image data in a longitudinal direction (step S1805).

The characteristic-feature acquiring unit 1502 calculates the amount of variation in measured width (step S1806).

The determining unit 1503 determines whether a calculated amount of variation is larger than a predetermined threshold (step S1807). When the amount of variation is larger than a predetermined threshold (Yes at step S1807), the determining unit 1503 increments the captured-image benchmark (step S1808). On the other hand, when the amount of variation is equal to or smaller than a predetermined threshold (No at step S1807), the determining unit 1503 increments the true-electronic-image benchmark (step S1809).

The characteristic-feature acquiring unit 1502 increments parameter n (step S1810), and determines whether parameter n is larger than the number of ruled lines (step S1804).

When parameter n is larger than the number of ruled lines (Yes at step S1804), the determining unit 1503 determines whether the captured-image benchmark is larger than the true-electronic-image benchmark (step S1811). When the captured-image benchmark is larger than the true-electronic-image benchmark (Yes at step S1811), the determining unit 1503 determines that an image is a captured image (step S1812), and the process ends.

On the other hand, when the captured-image benchmark is equal to or smaller than the true-electronic-image benchmark (No at step S1811), the determining unit 1503 determines that an image is a true electronic image (step S1813), and the process ends.

According to the fourth embodiment, the image processing apparatus 1500 can precisely determine whether an image is a captured image or a true electronic image even when image data is binary image data.

If input image data is binary image data, the image processing unit 205 does not need to perform grayscale processing or binary processing. However, the image processing unit 205 can perform skew correction or other image processing on a captured image as appropriate.

It is explained in the fourth embodiment that whether an image is a captured image or a true electronic image is determined based on the amount of variation in width of a ruled line in binary image data. However, it is possible to perform such determination based on the amount of variation in width of a ruled line in multilevel image data instead of binary image data.

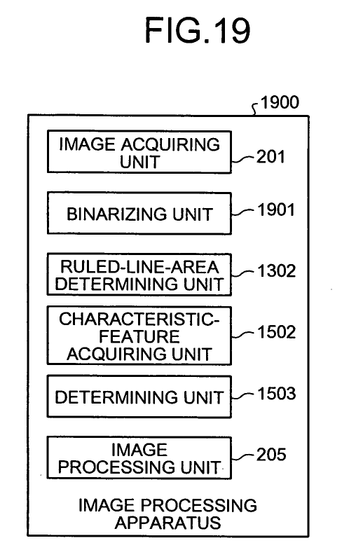

FIG. 19 is a functional block diagram of an image processing apparatus 1900 according to a fifth embodiment of the present invention. The image processing apparatus 1900 includes a binarizing unit 1901 in addition to the configuration of the image processing apparatus 1500. The same components are assigned with the same reference numerals, and their explanations are omitted.

The binarizing unit 1901 performs binary processing on multilevel image data if image data acquired by the image acquiring unit 201 is multilevel image data.

Other processing is the same as those described in the fourth embodiment, and the same explanation is not repeated. According to the fifth embodiment, it is possible to determine whether image data is a captured image or a true electronic image even when the image data is multilevel image data.

Furthermore, when multilevel image data is binarized, it is possible to determine the type of image data based on a distribution value in a predetermined area of binarized image data instead of the amount of variation in width of a ruled-line area. Specifically, it is possible to perform such determination based on a distribution value of character colors in binary image data.

It is explained in the third to the fifth embodiments that whether image data is a captured image or a true electronic image is determined by determining a ruled-line area and performing the above processing on all ruled lines. However, other processing procedures are also applicable.

A first modification of the third to the fifth embodiments is described below. An image processing apparatus according to the first modification determines a priority order of ruled lines to be processed, calculates a distribution value or the amount of variation in width in the priority order, determines whether image data is a captured image based on a calculation result, and terminates a process immediately after the image data is determined to be a captured image. The image processing apparatus according to the first modification is of basically the same configuration as described previously in connection with FIGS. 13, 15, and 19.

A characteristic-feature acquiring unit of the image processing apparatus according to the first modification sorts ruled lines in a descendant order of pixels (or areas) of a ruled-line area determined by a ruled-line-area determining unit. Then, a determining unit calculates a pixel distribution value of ruled lines or the amount of variation in width of ruled lines in a descending order of pixels (areas) thereby determining whether the distribution value or the amount of variation exceeds a predetermined threshold. When the distribution value or the amount of variation exceeds a predetermined threshold, the determining unit determines that image data is a captured image, and terminates processes without performing processing on other ruled lines.

A ruled line having a large area is considered as a wide and long ruled line, so that it can be considered that a determination result from such a wide and long ruled line is more reliable than a determination result from a ruled line having a small area.

When the determining unit finishes processing on all ruled lines in the priority order, and does not determines that image data is a captured image, the determining unit determines that image data is a true electronic image.

As described above, the determining unit can perform a determination process on ruled lines by taking priority on a processing result from a ruled line having a large area than a processing result from a ruled line having a small area.

The reason of taking such priority is described below. Assume that one ruled line has a width of one dot, and its width is changed to two dots due to slight inclination of the ruled line. Furthermore, assume that other ruled line has a width of twenty dots and its width is changed to twenty-one dots due to slight inclination. In this case, a distribution value of the entire width of the former ruled line becomes larger than that of the latter one, resulting in mistakenly determine that image data is a captured image. By taking priority on a determination result from a ruled line having a large area, it is possible to prevent such mistake. Specifically, if priority order of ruled lines is determined based on the amount of pixels in ruled lines (i.e., based on the area of a ruled line), even when a width of a ruled line is changed from one dot to two dots due to slight inclination, priority order of such ruled line becomes low. Therefore, it is possible not to determine that image data is a captured image even when a ruled line having a small area is slightly inclined. As a result, it is possible to prevent a situation where image data is mistakenly determined as a captured image based on slightly-inclined ruled lines.

Furthermore, it is possible to determine that image data is a captured image when characteristic features indicative of a captured image is detected for a predetermined number of times unlike when determination is performed and process control is terminated based on one ruled line.

Moreover, the characteristic-feature acquiring unit can calculate a distribution value or the amount of variation by excluding some dots of pixels instead of scanning all pixels in a ruled line. As a result, it is possible to increase a processing speed.

According to the first modification, the image processing apparatus terminates a process when image data is a captured image based on a ruled line on a high priority order. Therefore, it is possible to reduce processing time.

Furthermore, ruled lines to be processed are sorted, so that it is possible to effectively maintain a processing speed and processing precision.

Ruled lines can be sorted by other factors instead of their area. A second modification of the third to the fifth embodiments is described below. An image processing apparatus according to the second modification sorts ruled lines by their lengths.

A characteristic-feature acquiring unit according to the second modification sorts ruled lines in a descendant order by their lengths in a ruled-line area determined by a ruled-line-area determining unit of the image processing apparatus. A determining unit of the image processing apparatus calculates pixel value distribution of a ruled line or the amount of variation in width of a ruled line in an order from the longest ruled line. Then, the determining unit determines whether the distribution value or the amount of variation exceeds a predetermined threshold. When the distribution value or the amount of variation exceeds the predetermined threshold, the determining unit determines that image data is a captured image, and terminates processing without performing processing on other ruled lines.

It is also possible in the second modification to calculate a distribution value or the amount of variation by excluding some dots of pixels of image data in a longitudinal direction.

According to the second modification, the amount of variation in width of a ruled line can be calculated form a length of a ruled line for determining whether image data is a captured image. Furthermore, it is possible to increase precision of a determination process and reduce processing time.

A third modification of the third to the fifth embodiments is described below. An image processing apparatus according to the third modification normalizes data without sorting ruled lines.

A characteristic-feature acquiring unit of the image processing apparatus according to the third modification does not sort ruled lines in a ruled-line area determined by a ruled-line-area determining unit, calculates a pixel value distribution of a ruled line or the amount of variation in width of a ruled line from twenty portions of the entire ruled line regardless of the length of a ruled line. Then, a determining unit of the image processing apparatus determines whether the distribution value and the amount of variation exceeds a predetermined threshold. The number of portions for performing a determination process is not limited to twenty, and any predetermined number is applicable.

According to the third modification, data amount to be obtained can be maintained at constant even when a length of a ruled line changes. Therefore, it is possible to stably perform determination regardless of a length of a ruled line.

A fourth modification of the third to the fifth embodiments is described below. An image processing apparatus according to the fourth modification performs determination processing on not all ruled lines but limited ruled lines unlike those described in the third to the fifth embodiments and the first to the third modification.

Specifically, when input image data is a table or a document like a ledger sheet, the input image data contain a number of ruled lines.

If the number of ruled lines increases, data amount also increase, improving precision in determination processing. However, if all ruled lines are extracted and extracted lines are all processed, more processing time is necessary and processing loads increase. Specifically, if a several tens of ruled lines having the same width and same interval are processed, it is disadvantageous in that processing loads increase even if processing precision increases.

A characteristic-feature acquiring unit of the image processing apparatus selects a ruled-line area to be processed from ruled-line areas determined by a ruled-line-area determining unit of the image processing apparatus, and performs processing on a selected ruled-line area. Specifically, ruled lines can be selected in such a manner that short ruled lines are excluded, or when ruled lines are arranged in parallel, every predetermined number of ruled lines is processed. In this manner, the image processing apparatus according to the fourth modification performs processing only on necessary ruled lines.

For example, it is possible to determine to perform processing on a predetermined ratio of detected ruled lines, i.e., only twenty ruled lines are processed when a hundred of ruled lines are detected. If ten ruled lines or more are determined as a captured image from among twenty ruled lines, the process ends. If it is not determined that image data is not a captured image even after twenty ruled lines are processed, the process ends without processing on the rest of eighty ruled lines.

The above described embodiments and modifications can be applied singularly or in combination with one another.

For example, it is possible to perform determination processing on twenty ruled lines in a priority order of their lengths when a hundred of ruled lines are detected.

According to the fourth modification, it is possible to effectively maintain a processing speed and processing precision by discarding some ruled lines.

According to an aspect of the present invention, it is possible to perform appropriate image processing depending the type of input image data. As a result, it is possible to reduce processing time and improve processing precision.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an image acquiring unit that acquires image data;
a feature acquiring unit that acquires a characteristic feature of the image data;
a determining unit that determines type of the image data based on the characteristic feature; and
an image processing unit that performs image processing on the image data depending on the type of the image data.

2. The image processing apparatus according to claim 1, further comprising an area determining unit that determines a target area of the image data from which the characteristic feature is extracted, wherein
the feature acquiring unit acquires the characteristic feature from the target area.

3. The image processing apparatus according to claim 2, wherein
the feature acquiring unit acquires, as the characteristic feature, a distribution value indicative of distribution of pixel values, and
the determining unit determines the type of the image data based on whether the distribution value exceeds a threshold.

4. The image processing apparatus according to claim 2, wherein the area determining unit determines an area, as the target area, included in a background area of the image data.

5. The image processing apparatus according to claim 1, further comprising a color clustering unit that performs color clustering on the image data, and generates color clusters indicative of classification of colors in the image data, wherein
the feature acquiring unit acquires the characteristic feature for each of the color clusters.

6. The image processing apparatus according to claim 5, wherein
the feature acquiring unit acquires, as the characteristic feature, a distribution value indicative of distribution of pixel values, and
the determining unit determines the type of the image data based on whether the distribution value exceeds a threshold.

7. The image processing apparatus according to claim 1, further comprising:
a binarizing unit that performs binary processing on the image data, and generates binary image data from the image data; and
a ruled-line-area determining unit that determines a ruled-line area in the binary image data, wherein
the feature acquiring unit acquires the characteristic feature from an area of the image data corresponding to the ruled-line area.

8. The image processing apparatus according to claim 1, further comprising a ruled-line-area determining unit that, when the image data is binary image data, determines a ruled-line area in the binary image data, wherein
the feature acquiring unit acquires, as the characteristic feature, an amount of variation in width of a ruled line in a longitudinal direction in the ruled-line area.

9. The image processing apparatus according to claim 7, wherein
the feature acquiring unit acquires, as the characteristic feature, a distribution value indicative of distribution of pixel values, and
the determining unit determines the type of the image data based on whether the distribution value exceeds a threshold.

10. The image processing apparatus according to claim 8, wherein
the feature acquiring unit acquires, as the characteristic feature, a distribution value indicative of distribution of pixel values, and
the determining unit determines the type of the image data based on whether the distribution value exceeds a threshold.

11. The image processing apparatus according to claim 1, wherein the image processing unit controls at least one of grayscale processing, binary processing, and skew correction processing depending on the type of the image data.

12. An image processing method comprising:
receiving image data;
acquiring a characteristic feature of the image data;
determining type of the image data based on the characteristic feature; and
performing image processing on the image data depending on the type of the image data.

13. The image processing method according to claim 12, further comprising determining a target area of the image data from which the characteristic feature is extracted, wherein
the acquiring includes acquiring the characteristic feature from the target area.

14. The image processing method according to claim 12, further comprising:
binarizing the image data to generate binary image data from the image data; and
determining a ruled-line area in the binary image data, wherein
the acquiring includes acquiring the characteristic feature from an area of the image data corresponding to the ruled-line area.

15. The image processing method according to claim 12, further comprising:
binarizing the image data when the image data is multilevel image data to generate binary image data; and
determining a ruled-line area in the binary image data, wherein
the acquiring includes acquiring, as the characteristic feature, an amount of variation in width of a ruled line in a longitudinal direction in the ruled-line area.

16. A computer program product comprising a computer usable medium having computer readable program codes embodied in the medium that, when executed, causes a computer to execute:
receiving image data;
acquiring a characteristic feature of the image data;
determining type of the image data based on the characteristic feature; and
performing image processing on the image data depending on the type of the image data.

17. The computer program product according to claim 16, further causing the computer to execute determining a target area of the image data from which the characteristic feature is extracted, wherein
the acquiring includes acquiring the characteristic feature from the target area.

18. The computer program product according to claim 16, further causing the computer to execute:
binarizing the image data to generate binary image data from the image data; and
determining a ruled-line area in the binary image data, wherein
the acquiring includes acquiring the characteristic feature from an area of the image data corresponding to the ruled-line area.

19. The computer program product according to claim 16, further causing the computer to execute:
binarizing the image data when the image data is multilevel image data to generate binary image data; and
determining a ruled-line area in the binary image data, wherein
the acquiring includes acquiring, as the characteristic feature, an amount of variation in width of a ruled line in a longitudinal direction in the ruled-line area.
